(19) United States
(12) Patent Application Publication
(10) Pub. No.: US 2026/0036106 A1
(43) Pub. Date: Feb. 5, 2026

(54) FUEL INJECTOR

(71) Applicant: Robert Bosch GmbH, Stuttgart (DE)

(72) Inventors: Martin Rainer, Puch bei Hallein (AT); Walter Walkner, Hallein (AT); Alexander Fuchs, Adnet (AT)

(21) Appl. No.: 18/996,068

(22) PCT Filed: Jul. 17, 2023
(86) PCT No.: PCT/EP2023/069750

§ 371 Date: Jan. 17, 2025

(30) Foreign Application Priority Data
Jul. 20, 2022 (DE) 10 2022 207 401.7

(51) Int. Cl. F02M 55/04; F02M 21/02; F02M 55/00

(52) U.S. Cl. CPC F02M 55/04; F02M 21/0248; F02M 55/004

(57) ABSTRACT

A fuel injector for metered delivery of a gaseous or liquid fuel having a housing (1) in which a compensating chamber (3) bounded by a tubular crimping bellows (5) and fillable with a lubricant is formed, wherein the crimping bellows (5) is connected at one end with a first connecting part (7) and at the other end with a second connecting part (8) by a fluid-tight connection. A thread (12) and a screwing surface (15; 17; 20; 32) accessible from the interior of the crimping bellows (5) are formed on the first connecting part (7), wherein a screwing force can be applied to the first connecting part (7) on the screwing surface (15; 17; 20; 32) by means of a force- or positive-locking connection with a tool (18) or with another component (8) of the fuel injector, in order to screw it into a fastening thread (13) in the housing (1).

### BACKGROUND

The invention relates to a fuel injector as used for metered delivery of a gaseous or liquid fuel, for example for delivery of a fuel into a combustion chamber of an internal combustion engine.

Fuel injectors for metered delivery of gaseous or liquid fuel with a movable valve element, which may in particular be in the form of a valve needle, are known from DE 10 2015 226 491 A1, for example. The valve element or the valve needle comprises a valve plate with which the valve element engages with a valve seat in order to open and close a flow cross section. The valve element is moved against the force of a closing spring using an electromagnet. Because fuels, particularly gaseous fuels, have little to no lubrication properties, the guides of the valve element within the fuel injector are supplied with a separate lubricant. To this end, a compensating chamber around the valve element is cut off by a crimping bellows in order on the one hand to maintain the mobility of the valve element and on the other hand to ensure a seal against the fuel in the fuel injector. The bellows is connected at its ends directly to the valve element or to connecting parts by welding to obtain a media-tight connection that permanently prevents the mixing of lubricant and fuel.

As the valve element moves, the volume of the compensating chamber bounded by the crimping bellows changes. To compensate for this, the compensating chamber is connected via recesses or bores to a compensating chamber, also bounded by a crimping bellows, which reduces its volume when the valve element moves accordingly so that the total volume of the compensating chamber and the compensating chamber remains the same. The bellows of the compensating chamber is connected at its ends to connecting parts that are screwed into corresponding mounting threads in the housing of the fuel injector. Since a bellows may not transfer any or may transfer only low torsion forces, the connecting parts must be screwed in first and then the weld connection to the bellows must be completed. This is technically complex and needs to be considered when designing the fuel injector.

### SUMMARY

The fuel injector according to the invention for metered delivery of a gaseous or liquid fuel has the advantage that simple and inexpensive assembly of the crimping bellows is possible. To this end, the fuel injector comprises a housing in which a lubricant-fillable compensating chamber is formed, bounded by a tubular crimping bellows. The crimping bellows is connected at one end with a first connecting part and to the other end with a second connecting part to create a fluid-tight connection, wherein both a gas and a liquid are understood as fluid in the context of this patent application. A thread and a screwing surface accessible from the interior of the crimping bellows are formed on the first connecting part. A torsion force can be exerted on the first connecting part via the screwing surface by means of a force- or positive-locking connection with a tool or with another component of the fuel injector in order to screw it into a fastening thread.

To arrange the crimping bellows within the housing, it is connected to a first connecting part via a first welded connection, and the crimping and connecting part are subsequently introduced into the housing. They are fastened in the housing by applying a screwing force from the interior of the crimping bellows to the first connecting part and screwing the first connecting part into the fastening thread in the housing. This eliminates the need to apply a screwing force via the crimping bellows, which facilitates mounting of the crimping bellows within the housing.

In a first advantageous embodiment, the screwing surface in the first connecting part is configured as a polygon socket, in particular a hexagon socket. Through an opening in the second connecting part, a tool having a polygonal profile can be inserted into the interior of the crimping bellows, wherein the tool is brought into a positive-locking fit with the polygonal profile. Thus, a screwing force may be applied to the first connecting part without mechanically loading the crimping bellows. The opening in the second connecting part can then be sealed in a fluid-tight manner by a closure element.

In a further advantageous embodiment, a polygonal profile screw surface is formed on the first connecting part and a polygonal socket is formed on the second connecting part so that the second connecting part can be brought into positive-locking fit with the polygonal profile of the first connecting part. The second connecting part may be pushed towards the first connecting part by compression of the corrugated bellows until the polygonal profile on the first connecting part is brought into a positive-locking fit with the polygonal socket of the second connecting part. The second connecting part can then be rotated, which also moves the first connecting part due to the positive-locking fit, without the torsion causing a mechanical load on the crimping bellows. If the first connecting part is screwed into the fastening thread, the second connecting part can be retracted and the polygonal profile and the polygonal socket can be separated from each other again until the compensating chamber has its original shape. No additional tool is required for this purpose.

In a further advantageous embodiment, the friction surface is configured as a first friction surface perpendicular to the axis of the thread on the first connecting part. A second friction surface, which is correspondingly aligned parallel to the first friction surface and which can be brought into contact with the first friction surface by compression of the corrugated bellows for transferring the screwing force, is present on the second connecting part. Similar to the configuration of a polygonal profile and socket on the first and second connecting parts, a torsion force can be transferred via the two friction surfaces without any mechanical load being exerted on the crimping bellows.

In a further advantageous embodiment, flats are configured on the outer side of the second connecting part for exerting a screwing force. In particular, if the second connecting part is connected to the first connecting part via a force- or positive-locking connection, the necessary force can be exerted on the first connecting part via these flats.

In a further advantageous embodiment, a sealing surface is formed on the first connecting part, which abuts a sealing seat when the first connecting part is screwed into the fastening thread. A fluid-tight connection between the first connecting pat and the housing is thereby achieved and the compensating chamber is sealed.

### BRIEF DESCRIPTION OF THE DRAWINGS

Various exemplary embodiments of the fuel injector according to the invention are shown schematically in the drawing, wherein only the significant area of the fuel injector is shown. The following is shown in the figures:

FIG. 1 a longitudinal section through a known fuel injector in the area of a crimping bellows,

FIG. 2 a first exemplary embodiment of the crimping bellows according to the invention with its connecting parts and

FIG. 2a, a suitable screw tool,

FIG. 3 a further exemplary embodiment as well as

FIG. 4 in the same illustration as FIG. 2.

### DETAILED DESCRIPTION

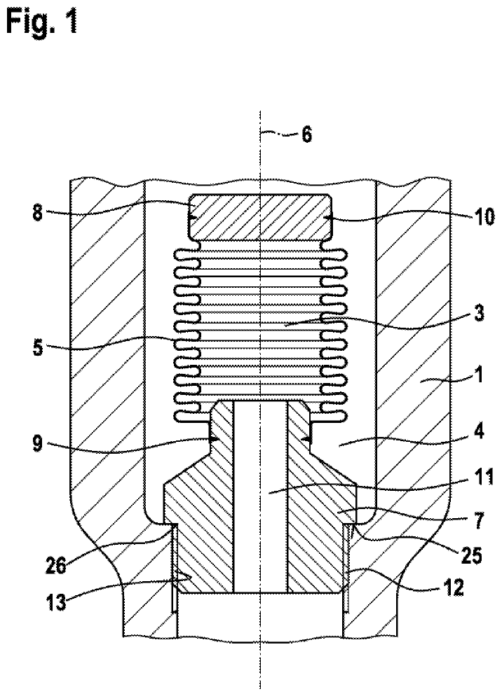

FIG. 1 shows a longitudinal section of a known fuel injector for metered delivery of a gaseous or liquid fuel. The fuel injector comprises a housing 1 in which a compensating chamber 3 is formed, which can be filled with a lubricant and which is bounded by a crimping bellows 5. Between the crimping bellows 5 and the wall of the housing 1, there remains an annular space 4, which can be filled with ambient air, for example. The crimping bellows 5 is connected to a first connecting part 7 via a first weld connection 9 to form a fluidic connection. The first connecting part 7 comprises a thread 12 formed on the outer side, which is a fastening thread 13 screwed into the inside of the housing 1. A sealing surface 25 in the form of an annular surface is formed on the first connecting part 7, which engages with a sealing seat 26 to form a fluid-tight connection. Axially spaced apart from the first connecting part 7, a second connecting part 8 is present in the housing 1, with which the bellows 5 is connected by means of a second weld connection 10 at its end opposite the first connecting part 7. The compensating chamber 3 is thus bounded by the crimping bellows 5 and the second connecting part 8. A ventilation bore 11 is formed in the first connecting part 7, via which the compensating chamber 3 is connected to further areas of the fuel injector filled with lubricant. This may be, for example, another bellows filled with lubricant in which a valve element is movably disposed.

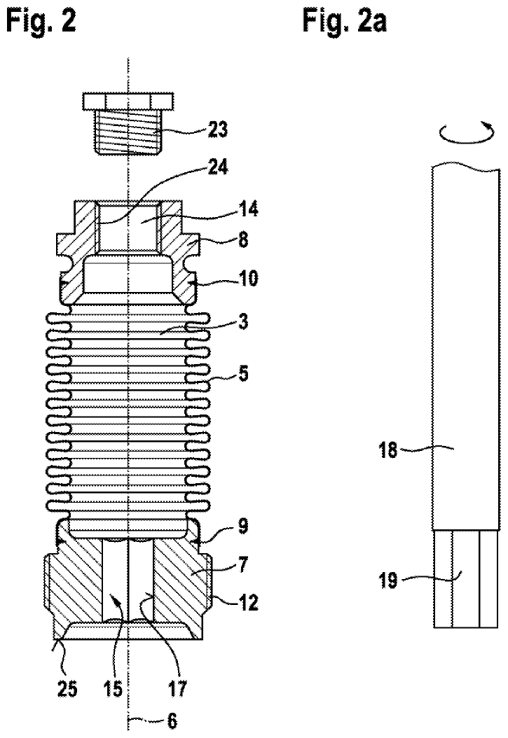

In order to screw the first connecting part 7 into the fastening thread 13, a torsion force must be applied to the first connecting part 7. For this purpose, FIG. 2 shows a first exemplary embodiment of the invention in the same representation as FIG. 1, wherein the housing 1 was omitted here for clarity. The ventilation bore 11 in the first connecting part 7 is configured here as a screwing surface 15 in the form of a polygonal socket 17, for example as an hexagonal socket. The screwing surface 15 thus formed is accessible from the interior of the crimping bellows 5. A tool 18 can be inserted via an opening 14 in the second connecting part 8, which is shown schematically in FIG. 2a. The tool 18 has a polygonal profile 19 at its end, which can be brought into engagement with the polygonal socket 17 to screw the first connecting part 7 into the fastening thread 13 without a torsion force being applied on the crimping bellows 5. The second connecting part 8 also rotates via the crimping bellows 5 because of the connection to the first connecting part 7. It is also possible to form the opening 14 with a polygonal socket so that the tool 18 can be brought into simultaneous engagement with both connecting parts 7, 8 with a correspondingly longer polygonal profile 19. After the first connecting part 7 is screwed into the fastening thread 13, the tool 18 is removed again. The opening 14 can then be closed by a closure element 23, which is configured here in the form of a closing screw with an external thread. In this case, a corresponding internal thread 24 is formed on the inner side of the opening 14.

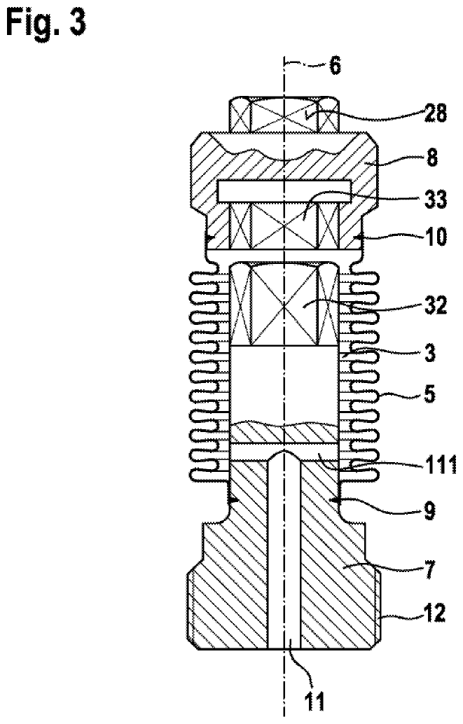

In FIG. 3, a further exemplary embodiment of the fuel injector according to the invention and the crimping bellows 5 with its connecting parts 7, 8 is shown. The first connecting part 7 is configured here as extended relative to the exemplary embodiment of FIG. 2 and comprises a polygonal profile 32, which forms the end of the first connecting part 7 facing the second connecting part 8. Accordingly, a polygonal socket 33 is formed in the second connecting part 8, which is spaced apart from the first connecting part 7 when the crimping bellows 5 is relaxed. To screw the first connecting part 7 into the fastening thread 13, the second connecting part 8 is pressed by compressing the corrugated bellows 5 towards the first connecting part 7 until the polygonal socket 33 slips into the polygonal profile 32 and thereby forms a positive-locking connection. Both connecting parts 7, 8 can be rotated together and the first connecting part 7 can be thereby rotated into the fastening thread 13. The torsion force can be exerted via flats 28, which are shown in FIG. 3 at the upper end of the second connecting part 8. Here as well, there are no mechanical torsion loads on the crimping bellows 5 and thus no interference with the weld joints 9, 10. Upon completion of the screwing operation, the second connecting part 8 is moved away from the first connecting part 7 again so that the compensating chamber 3 within the crimping bellows 5 returns to its original shape and size.

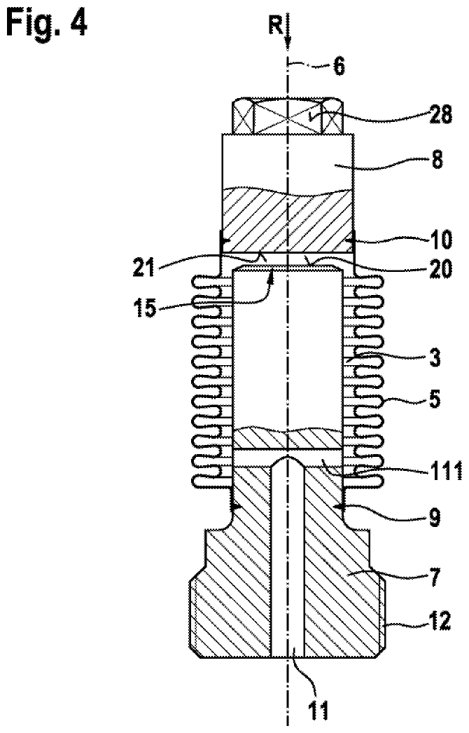

FIG. 4 shows another exemplary embodiment illustrated in the same manner as FIG. 3. The connection between the first connecting part 7 and the second connecting part 8 is completed here via a screwing surface, which is formed as the first friction surface 20. The first friction surface 20 is formed on the first connecting part 7 and a corresponding second friction surface 21 is formed on the second connecting part 8. Both friction surfaces 20, 21 are aligned perpendicular to the longitudinal axis 6 of the thread 12 and are opposite to each other. For the screw connection, the second connecting part 8 is moved in direction R towards the first connecting part 7 by compressing the corrugated bellows 5 until the friction surfaces 20, 21 are on top of each other. The friction surfaces 20, 21 have a high roughness so that they can adhere well to each other and corresponding shear forces can be transferred. By rotating the second connecting part 8, a torsion force is now applied to the first connecting part 7 and it is screwed into the fastening thread 13. After the screw fitting is complete, the second connecting part 8 is moved away from the first connecting part 7, so that the compensating chamber 3 returns to its original shape. The ventilation bore 11 is connected to a transverse bore 111 due to the extended first connector 8 in order to connect the compensating chamber 3 inside the crimping bellows 5 to the outside.

1. A fuel injector for metered delivery of a gaseous or liquid fuel having a housing (1) in which a compensating chamber (3) bounded by a tubular crimping bellows (5) and fillable with a lubricant is formed, wherein the crimping bellows (5) is connected at one end with a first connecting part (7) and at another end with a second connecting part (8) in a fluid-tight manner,
wherein
a thread (12) and a screwing surface (17; 20; 32) accessible from an interior of the crimping bellows (5) are formed on the first connecting part (7), wherein a screwing force can be applied to the first connecting part (7) on the screwing surface (17; 20; 32) by a force- or positive-locking connection with a tool (18) or with another component (8) of the fuel injector, in order to screw the first connecting part (7) into a fastening thread (13) in the housing (1).

2. A The fuel injector according to claim 1, wherein the screwing surface in the first connecting part (7) is formed as a polygonal socket (17).

3. The fuel injector according to claim 2, wherein an opening (14) is formed in the second connecting part (8), through which a tool (18) with a polygonal profile (19) can be inserted into the interior of the crimping bellows (5) and which tool (18) can be brought into a positive-locking connection with the polygonal socket (17).

4. The fuel injector according to claim 3, wherein the opening (14) in the second connecting part (8) can be sealed fluid-tight by a closure element (23).

5. A The fuel injector according to claim 1, wherein the screwing surface in the form of a polygonal profile (32) is formed on the first connecting part (7) and a polygonal socket (33) is formed on the second connecting part (8) such that the second connecting part (8) can be brought into positive-locking engagement with the polygonal profile (32) of the first connecting part (7) by compressing the crimping bellows (5).

6. The fuel injector according to claim 1, wherein the screwing surface is a first friction surface (20) formed perpendicular to a longitudinal axis (6) of the thread (12) on the first connecting part (7) and a second friction surface (21) is formed on the second connecting part (8) aligned parallel to the first friction surface (20), wherein the first friction surface (20) can be brought into contact with the second friction surface (21) by compressing the crimping bellows (5) for transmission of the screwing force.

7. The fuel injector according to claim 1, wherein flats (28) are configured on an outer side of the second connecting part (8) to exert a screwing force.

8. The fuel injector according to claim 1, wherein a sealing surface (25) is formed on the first connecting part (7), which causes a formation of a fluid-tight connection when the first connecting part (7) is screwed into the fastening thread (13) at a sealing seat (26).

9. The fuel injector according to claim 2, wherein the screwing surface in the first connecting part (7) is formed as a hexagonal socket.
